(19) United States
(12) Patent Application Publication
(10) Pub. No.: US 2021/0239241 A1
(43) Pub. Date: Aug. 5, 2021

(54) Adjustable Pipe Spool and Connection Methods

(71) Applicant: AWC Frac Valves Inc., Conroe, TX (US)

(72) Inventors: Chance R. Mullins, Spring, TX (US); Scott E. Linder, Montgomery, TX (US); Anthony J. Hanewinkel, Houston, TX (US); Dustin David Shefferd, Wellington, CO (US)

(21) Appl. No.: 16/780,407

(22) Filed: Feb. 3, 2020

(51) Int. Cl. F16L 15/02; F16L 27/12

(52) U.S. Cl. CPC F16L 15/02; F16L 27/127

(57) ABSTRACT

An adjustable pipe spool includes an outer body, an inner body at least partially disposed within the outer body, an adjustment ring rotationally coupled to the inner body, a lock ring rotationally coupled to the outer body and engaging the adjustment ring, a rotation key maintained within the outer body by the lock ring, the rotation key extending into a slot in the inner body. The inner body is axially translatable with respect to the outer body between a retracted configuration and an extended configuration, and the inner body is rotationally adjustable with respect to the outer body in the extended configuration.

### TECHNICAL FIELD

The present disclosure relates to an adjustable pipe spool and methods for coupling the adjustable pipe spool to other equipment.

### BACKGROUND

Pipe spools are used in many different industries to form operational connections to other equipment. Pipe spools may be used to provide a temporary or permanent connection to a single piece of equipment, or between two pieces of equipment, and pipe spools are designed to withstand the operational conditions of the system. For example, a pipe spool may be designed for use within an oil and gas system to act as a flow conduit for fluids, gases, solids, or some combination thereof.

### SUMMARY

The present disclosure is directed to adjustable pipe spools and methods for coupling adjustable pipe spools to other equipment.

In an implementation, an adjustable pipe spool comprises an outer body; an inner body at least partially disposed within the outer body, the inner body having a slot defined by a length and a width; an adjustment ring rotationally coupled to the inner body; a lock ring rotationally coupled to the outer body and engaging the adjustment ring; and a rotation key maintained within the outer body by the lock ring, the rotation key extending into the slot. The inner body may be axially translatable with respect to the outer body between a retracted configuration and an extended configuration, and the inner body may be rotationally adjustable with respect to the outer body in the extended configuration.

In an implementation, the adjustable pipe spool further comprises an erosion ring coupled to a first end of the inner body. The erosion ring may move axially and rotationally with the inner body. The erosion ring may be disposed at least partially within the outer body. A first end of the erosion ring may engage the outer body when the inner body is in the retracted configuration. In an implementation, the erosion ring is formed of a different material than the inner body.

In an implementation, rotation of the adjustment ring with respect to the inner body causes the inner body to axially translate with respect to the outer body. The direction of rotation of the adjustment ring with respect to the inner body may cause the inner body to axially translate from the retracted configuration toward the extended configuration, or vice versa. The rotation key may engage a far end of the slot when the inner body is in the extended configuration. The rotational adjustability of the inner body with respect to the outer body may be limited by the width of the slot.

In another implementation, an adjustable pipe spool comprises an outer body, and an inner body at least partially disposed within the outer body. The inner body is axially translatable with respect to the outer body, and the inner body is rotationally adjustable with respect to the outer body. The adjustable pipe spool may further comprise an erosion ring coupled to a first end of the inner body, and the erosion ring may move axially and rotationally with the inner body. The erosion ring may be disposed at least partially within the outer body. In an implementation, the erosion ring is formed of a different material than the inner body. The adjustable pipe spool may further comprise an adjustment ring rotationally coupled to the inner body, wherein rotation of the adjustment ring with respect to the inner body may cause the inner body to axially translate with respect to the outer body. The adjustable pipe spool may further comprise a rotation key maintained within the outer body and extending into a slot in the inner body. The interaction between the rotation key and the slot may limit the axial translation of the inner body with respect to the outer body, and/or the interaction between the rotation key and the slot may limit the extent of rotational adjustability of the inner body with respect to the outer body.

In yet another implementation, an adjustable pipe spool comprises an outer body and an inner body, wherein at least one of the outer body and the inner body are axially translatable and rotationally adjustable. The adjustable pipe spool may further comprise an erosion ring coupled to the inner body. The inner body and the erosion ring may be at least partially disposed within the outer body. The inner body and the erosion ring may be axially translatable and rotationally adjustable with respect to the outer body.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1A illustrates a side schematic view of an operational assembly with an adjustable pipe spool of the present disclosure in a retracted configuration and coupled to a first piece of equipment.

FIG. 1B illustrates a side schematic view of the operational assembly of FIG. 1A, with the adjustable pipe spool of the present disclosure in an extended configuration and coupled between the first piece of equipment and a second piece of equipment.

FIG. 2 illustrates a side cross-sectional view of one implementation of an adjustable pipe spool shown in a fully retracted position, in accordance with the present disclosure.

FIG. 3 illustrates a side cross-sectional view of one implementation of an adjustable pipe spool shown in an extended position, in accordance with the present disclosure.

FIG. 4 illustrates a perspective view of one implementation of an adjustable pipe spool shown in an extended position, in accordance with the present disclosure.

FIG. 5 illustrates a perspective view, partially in cross-section, of one implementation of an adjustable pipe spool shown in an extended position, in accordance with the present disclosure.

FIG. 6 illustrates a perspective view of one implementation of an inner body of an adjustable pipe spool, in accordance with the present disclosure.

FIG. 7 illustrates a perspective cross-sectional view of one implementation of an adjustable pipe spool, depicting interactions between a rotation key and a slot on an inner body of the adjustable pipe spool, in accordance with the present disclosure.

FIG. 8 illustrates a side cross-sectional view of another implementation of an adjustable pipe spool with an optional erosion ring, the adjustable pipe spool shown in a fully retracted position, in accordance with the present disclosure.

FIG. 9 illustrates a side cross-sectional view of another implementation of an adjustable pipe spool with an optional erosion ring, the adjustable pipe spool shown in an extended position, in accordance with the present disclosure.

FIG. 10 illustrates a flow chart of a method for coupling an adjustable pipe spool into an operational assembly.

Like reference symbols in the various drawings indicate like elements.

### DETAILED DESCRIPTION

Pipe spools are used in many different industries to form operational connections to other equipment and to act as flow conduits for fluids, gasses, solids, and/or a combination thereof. For example, pipe spools may span between two pieces of operational equipment, thereby providing a flow conduit therebetween. Pipe spools have conventionally been constructed using a fixed length of pipe with flanges at each end. Due to this construction, each conventional pipe spool had to be custom fabricated to span the distance between two pieces of stationary equipment, and to properly orient the bolt holes of the pipe spool flanges with the bolt holes of the equipment flanges. Alternatively, a conventional pipe spool of a given length could be used with moveable equipment, such that at least one piece of equipment could be moved to adjust for any length differences (i.e. if the pipe spool was initially too short or too long to connect between the two pieces of equipment).

The present disclosure relates to adjustable pipe spools and methods for coupling adjustable pipe spools to other equipment. As described in more detail herein, the adjustable pipe spool may be extended or retracted as needed to adjust the length of the pipe spool for connection between two pieces of equipment. In addition, once the adjustable pipe spool has been extended to the desired length, the adjustable pipe spool may be rotationally adjusted to allow for bolt hole alignment when mating the adjustable pipe spool to equipment. Thus, the present disclosure is directed to an adjustable pipe spool that may be adjusted both axially and rotationally, and to methods of coupling the adjustable pipe spool to other equipment.

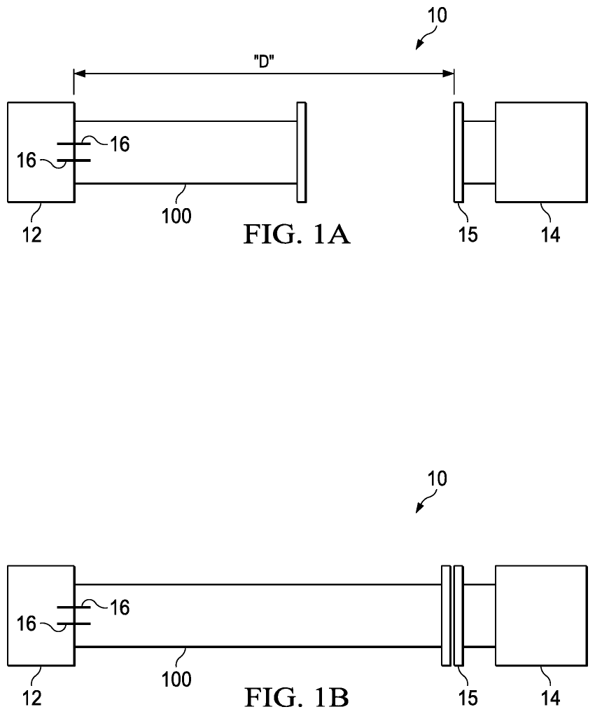

FIG. 1A and FIG. 1B illustrate side schematic views of an operational assembly 10 comprising a representative adjustable pipe spool 100, according to the present disclosure. In FIG. 1A, the adjustable pipe spool 100 is depicted in a fully retracted configuration, coupled to a first piece of equipment 12 via studs 16 and partially spanning the distance “D” towards a second piece of equipment 14. In FIG. 1B, the adjustable pipe spool 100 is depicted in an extended configuration, coupled to a flange 15 of the second piece of equipment 14, and coupled between the first piece of equipment 12 and the second piece of equipment 14.

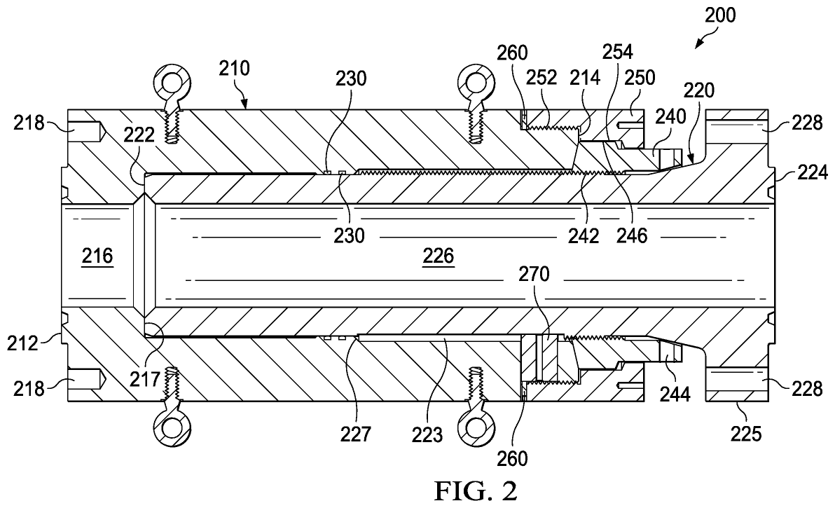

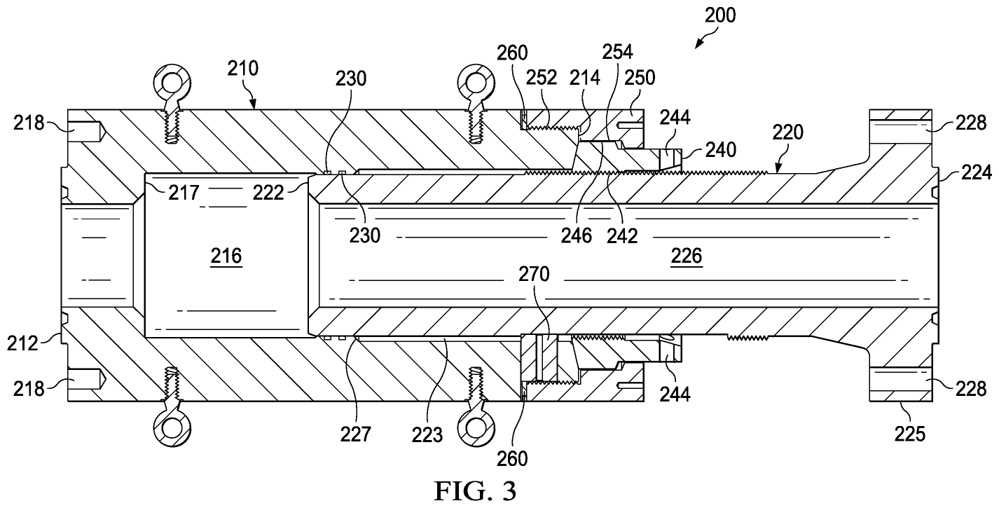

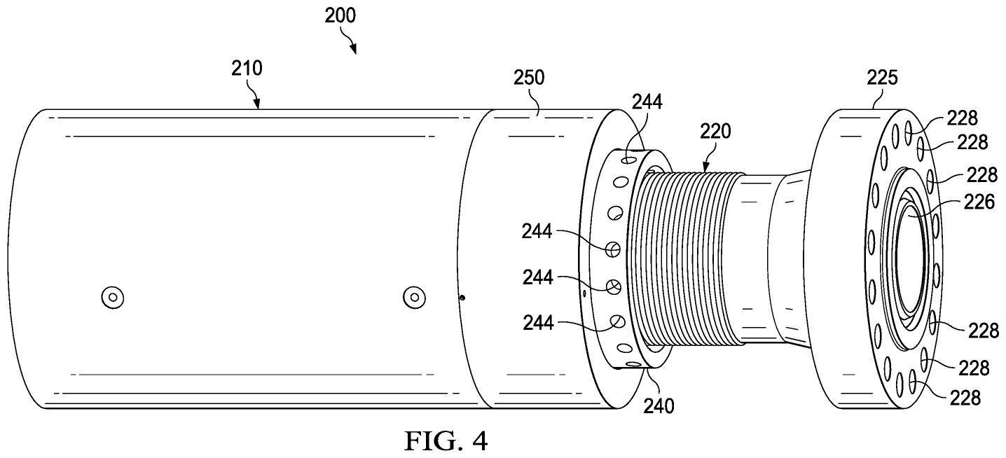

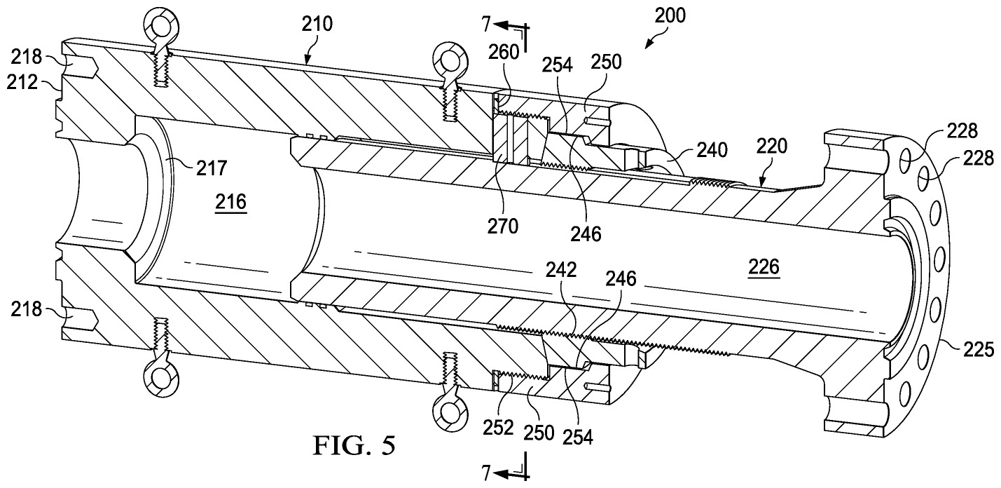

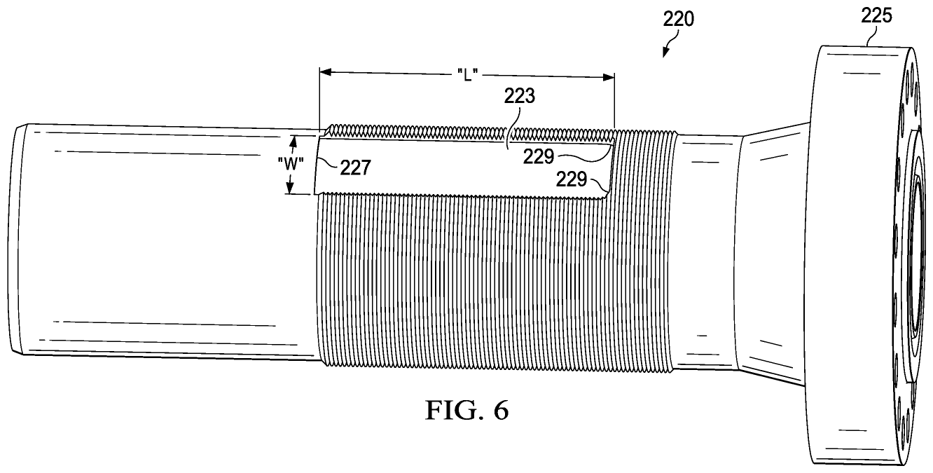

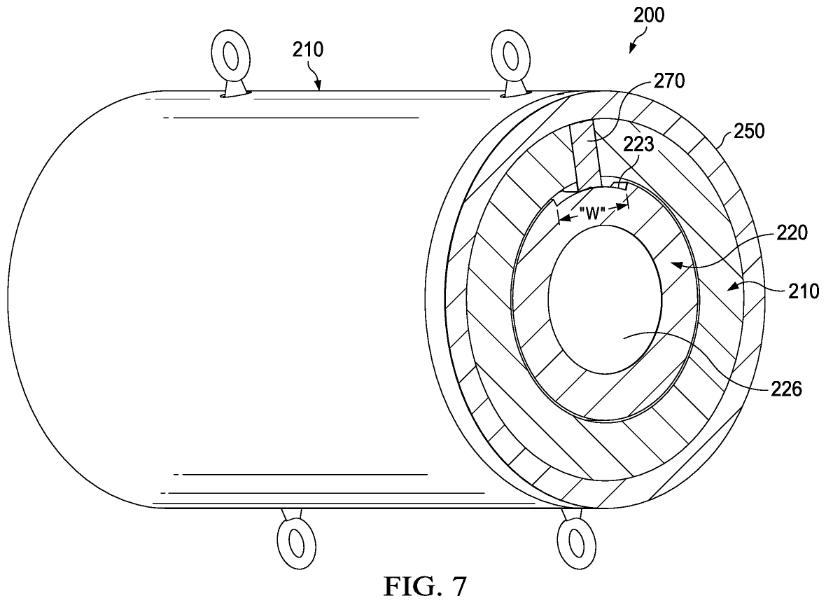

FIGS. 2-7 illustrate various views of one implementation of an adjustable pipe spool 200. In particular, FIG. 2 illustrates a cross-sectional view of the adjustable pipe spool 200 in a fully retracted position; FIG. 3 illustrates a cross-sectional view of the adjustable pipe spool 200 in an extended position; FIG. 4 illustrates a three-dimensional, perspective view of the adjustable pipe spool 200 in the extended position shown in FIG. 3; FIG. 5 illustrates a perspective, partial cross-sectional view, of the adjustable pipe spool 200 in the extended position shown in FIG. 3; FIG. 6 illustrates a three-dimensional, perspective view of an inner body 220 of the adjustable pipe spool 200; and FIG. 7 illustrates a perspective cross-sectional view of the adjustable pipe spool 200, taken along Section line 7-7 of FIG. 5.

Referring now to FIG. 2 and FIG. 3, the adjustable pipe spool 200 comprises a stationary outer body 210 and a moveable inner body 220 with seals 230 provided therebetween. The outer body 210 includes a first end 212, a second end 214, and borehole 216 therethrough. A plurality of longitudinal holes 218 are provided on the first end 212 of the outer body 210 for receiving studs (not shown) when coupling the adjustable pipe spool 200 to equipment, such as the first piece of equipment 12 shown in FIG. 1A and FIG. 1B.

Still referring to FIG. 2 and FIG. 3, the inner body 220 fits within the borehole 216 of the outer body 210 and engages a shoulder 217 therein when the inner body 220 is in the fully retracted position shown in FIG. 2. The inner body 220 includes a first end 222, a second end 224, and a borehole 226 therethrough. The second end 224 includes a flange 225 with longitudinal holes 228 for receiving studs (not shown) when coupling the adjustable pipe spool 200 to equipment, such as the second piece of equipment 14 shown in FIG. 1A and FIG. 1B. The inner body 220 is moveable with respect to the outer body 210, and the inner body 220 may be extended axially outwardly from the outer body 210, as depicted in FIG. 3.

Referring now to FIGS. 2-5, the adjustable pipe spool 200 further comprises an adjustment ring 240 that forms a threaded connection 242 to the inner body 220, a lock ring 250 that forms a threaded connection at 252 to the outer body 210, at least one set screw 260 that keeps the lock ring 250 from disconnecting from the outer body 210, and a rotation key 270.

The adjustment ring 240 is operable to axially translate the inner body 220 with respect to the outer body 210. In more detail, the adjustment ring 240 includes a plurality of axial holes 244 around its circumference, as best shown in FIG. 4. These axial holes 244 are designed to receive a bar (not shown) that a human operator may use to exert sufficient torque on the adjustment ring 240 to cause it to rotate. When the adjustment ring 240 rotates, the inner body 220 moves along threaded connection 242 to either extend or retract with respect to the outer body 210, depending upon the direction of rotation. The adjustment ring 240 is captured coaxially between the lock ring 250 and the outer body 210. Specifically, the lock ring 250 captures the adjustment ring 240 on the second end 214 of the outer body 210 via a shoulder 254 on the lock ring 250 interacting with a shoulder 246 on the adjustment ring 240.

Referring now to FIG. 6 and FIG. 7, the inner body 220 also includes a slot 223 on its outer surface, the slot 223 having a length “L” and a width “W”, as best shown in FIG. 6. The slot 223 on the inner body 220 is operable to receive the rotation key 270, which is captured in the outer body 210 by the lock ring 250, as best shown in FIG. 7, and also shown in FIG. 2 and FIG. 3. As described in more detail herein, the interaction between the slot 223 and the rotation key 270 limits both the axial extension of the inner body 220 with respect to the outer body 210, and the rotational movement of the inner body 220 with respect to the outer body 210.

Referring again to FIG. 1A and FIG. 1B, to couple the adjustable pipe spool 200 to the equipment 12, 14 of the operational assembly 10, the adjustable pipe spool 200 may initially be disposed in the fully retracted position shown in FIG. 2. As schematically depicted in FIG. 1A, the adjustable pipe spool is coupled in the fully retracted configuration to the first piece of equipment 12. In one implementation, that coupling is made via studs 16 that extend into the longitudinal holes 218 on the first end 212 of the outer body 210 and through the corresponding longitudinal holes on the first piece of equipment 12.

Then the adjustable pipe spool 200 may be transitioned to an extended position. When making that transition, the outer body 210 is stationary, but the inner body 220 is moveable axially outwardly from the retracted position shown in FIG. 2 to a desired extended position, as shown in FIG. 3, FIG. 4, and FIG. 5. Specifically, the inner body 220 may be extended axially to span the distance “D” between the first piece of equipment 12 and the second piece of equipment 14.

To axially extend the inner body 220, a human operator may insert a bar (not shown) into one of the axial holes 244 of the adjustment ring 240, as best shown in FIG. 4, and exert sufficient force on the bar to rotate the adjustment ring 240 and thereby cause the inner body 220 to extend outwardly with respect to the outer body 210. As the inner body 220 extends outwardly, the rotation key 270 interacts with the slot 223 on the inner body 220, and the amount of axial extension of the inner body 220 is limited by the length “L” of the slot 223, as best shown in FIG. 2, FIG. 3 and FIG. 6. In other words, depending upon how much the inner body 220 is extended axially with respect to the outer body 210, the rotation key 270 may engage the far end 227 of the slot 223 to stop further extension. In some implementations, the inner body 220 has an axial stroke of up to 13-inches.

To couple the adjustable pipe spool 200 to the second piece of equipment 14, as shown in FIG. 1B, the flange 225 on the second end 224 of inner body 220 mates with a flange 15 on the second piece of equipment 14. However, the longitudinal holes 228 of inner body flange 225 may not initially align with the longitudinal holes of the equipment flange 15. To correct for such misalignment, the inner body 220 is designed to rotationally adjust with respect to the outer body 210 when the adjustable pipe spool 200 is in an extended position. To make this rotational adjustment, a human operator may exert a rotational force via flange 225 to manually rotate the inner body 220 with respect to the outer body 210, or a human operator may use a bar (not shown) to pry against the axial holes 244 of the adjustment ring 240 with sufficient force to rotate both the inner body 220 and the adjustment ring 240 with respect to outer body 210. Via this rotational adjustment, a human operator can align the longitudinal holes of the respective flanges 225, 15, to then receive studs to complete the connection of the inner body 220 to the second piece of equipment 14. In some implementations, the inner body 220 may be rotated either clockwise or counterclockwise, and in some implementations, the inner body 220 may be rotated by about the distance between two bolt holes to allow for alignment of the longitudinal holes of the respective flanges 225, 15.

FIG. 6 and FIG. 7 depict the features involved when the inner body 220 is adjusted rotationally with respect to the outer body 210 to achieve a desired alignment once the proper axial extension is achieved. As best shown in FIG. 7, the rotation key 270 is captured within the slot 223 on the outer surface of the inner body 220. In some implementations, the rotation key 270 is narrower than the width “W” of the slot 223. When the inner body 220 is rotated with respect to the outer body 210, the rotation key 270 interacts with the slot 223, and the amount of rotation is limited by the width “W” of the slot 223, as best shown in FIG. 6 and FIG. 7. In other words, depending upon the amount of rotation between the inner body 220 and the outer body 210, the rotation key 270 may engage an edge 229 of the slot 223 to stop further rotation. As shown in FIG. 7, the rotation key 270 may initially be positioned at about the centerline of the width “W” of the slot 223 to allow for rotation of the inner body 220 either clockwise or counterclockwise.

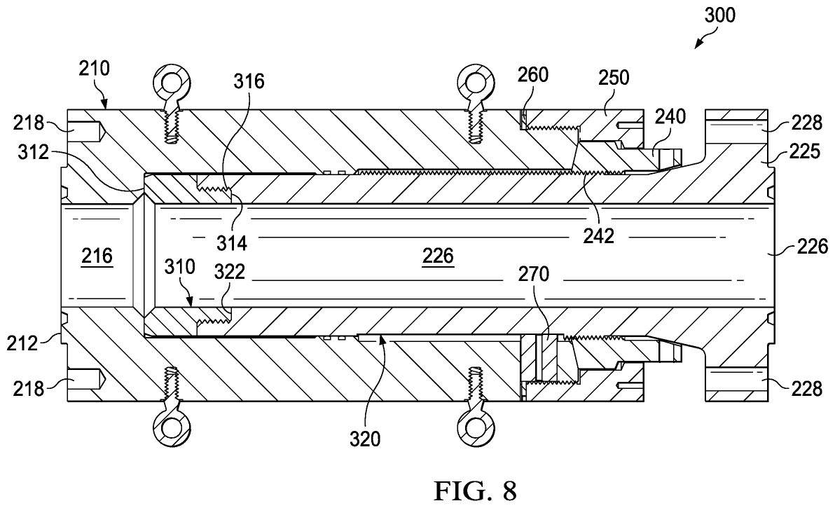

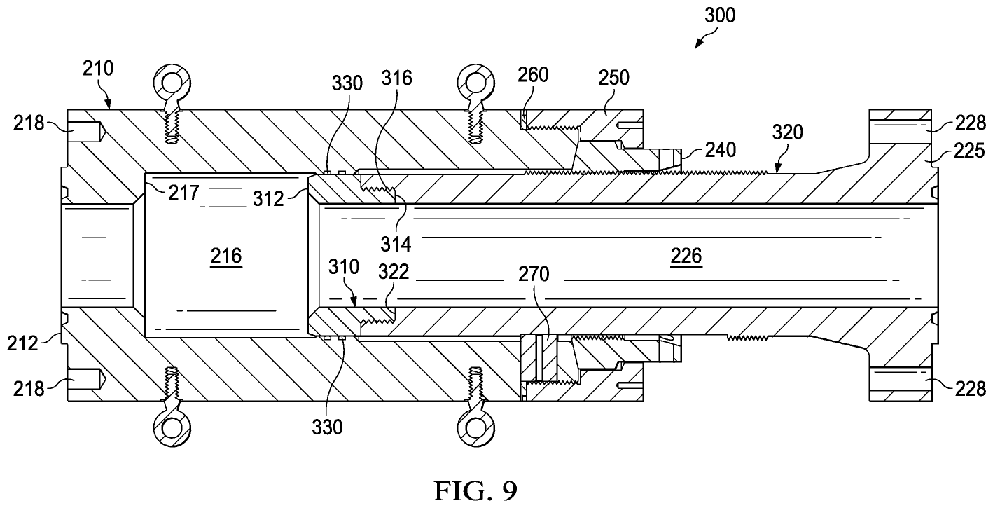

FIG. 8 and FIG. 9 illustrate another implementation of an adjustable pipe spool 300, according to the present disclosure. In particular, FIG. 8 illustrates a cross-sectional view of the adjustable pipe spool 300 in a fully retracted position and FIG. 9 illustrates a cross-sectional view of the adjustable pipe spool 300 in an extended position. Like reference numerals are used to indicate common features between the adjustable pipe spool 300 FIGS. 8-9 and the adjustable pipe spool 200 of FIGS. 2-7.

As with adjustable pipe spool 200, the adjustable pipe spool 300 may be extended or retracted as needed to adjust its overall length for connection between two pieces of equipment. In addition, once the adjustable pipe spool 300 has been extended to the desired length, it may be rotationally adjusted to allow for bolt hole alignment when mating the adjustable pipe spool 300 to equipment. Thus, like adjustable pipe spool 200, the adjustable pipe spool 300 may be adjusted both axially and rotationally, and the components that allow for such adjustments are similar in both implementations.

The adjustable pipe spool 300 may further comprise an optional erosion ring 310 with a first end 312 and a second end 314 that couples to another implementation of inner body 320 with a modified first end 322. In more detail, the optional erosion ring 310 is coupled at its second end 314 to the first end 322 of inner body 320 via a threaded connection 316. The optional erosion ring 310 and the inner body 320 fit within the borehole 216 of the outer body 210. Seals 330 are provided for pressure containment between the outer body 210 and the coupled inner body 320 and optional erosion ring 310. The first end 312 of the optional erosion ring 310 engages the shoulder 217 of the outer body 210 when the adjustable pipe spool 300 is in the fully retracted position shown in FIG. 8. Thus, the adjustable pipe spool 300 comprises the stationary outer body 210 and the moveable inner body 320 coupled to optional erosion ring 310.

Because the optional erosion ring 310 interacts with the outer body 210, the first end 322 of inner body 320 experiences less wear and abrasion during operation as compared to the first end 212 of the inner body 220 of adjustable pipe spool 200. Due to its function, in some implementations the optional erosion ring 310 may be formed of erosion and/or abrasion resistant material, or a base material with an abrasion resistant coating. In some implementations, the optional erosion ring 310 does not meet the same material requirements based on industry codes as the other components of the adjustable pipe spool 300. In some implementations, the optional erosion ring 310 may be made from extremely hard materials not feasible for the other components of the adjustable pipe spool 300. The optional erosion ring 310 may also be removable such that it may be replaced when it has sustained significant damage.

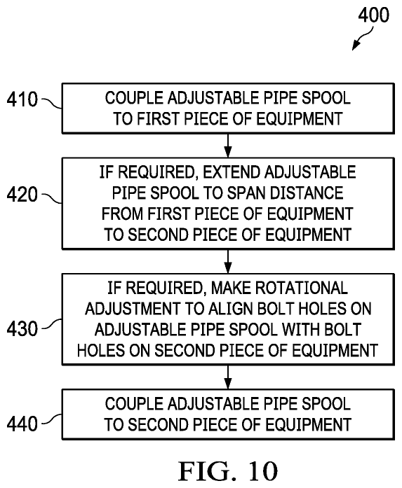

FIG. 10 illustrates a flow chart of a method 400 for coupling an adjustable pipe spool into an assembly. In some implementations, the method 400 may be used to couple any of adjustable pipe spools 100, 200, 300 between two pieces of equipment in any operational assembly, such as between equipment 12, 14 in operational assembly 10.

In Step 410, the method 400 comprises coupling an adjustable pipe spool to a first piece of equipment. During Step 410, the adjustable pipe spool may be in a fully retracted configuration or the adjustable pipe spool may be in a partially or fully extended configuration. In Step 420, the method 400 comprises axially extending the adjustable pipe spool, if required, to span the distance between the first piece of equipment and a second piece of equipment. In Step 430, the method 400 comprises making rotational adjustments, if required, to align bolt holes on the adjustable pipe spool with bolt holes on the second piece of equipment. In Step 440, the method 400 comprises coupling the adjustable pipe spool to the second piece of equipment.

Thus, the systems and methods of the present disclosure allow for more flexibility when coupling equipment in the field. Rather than custom fabricating a pipe spool for each operational assembly, the adjustable pipe spool of the present disclosure may function in many different operational assemblies due to its axial and rotational adjustability. The adjustable pipe spool and methods of the present disclosure also eliminate the need to move other equipment in the operational assembly when making connections.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. As another example, “coupling” includes direct and/or indirect coupling of members.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An adjustable pipe spool comprising:
an outer body;
an inner body at least partially disposed within the outer body, the inner body having a slot defined by a length and a width;
an adjustment ring rotationally coupled to the inner body;
a lock ring rotationally coupled to the outer body and engaging the adjustment ring; and
a rotation key maintained within the outer body by the lock ring, the rotation key extending into the slot;
wherein the inner body is axially translatable with respect to the outer body between a retracted configuration and an extended configuration; and
wherein the inner body is rotationally adjustable with respect to the outer body in the extended configuration.

2. The adjustable pipe spool of claim 1, further comprising:
an erosion ring coupled to a first end of the inner body;
wherein the erosion ring moves axially and rotationally with the inner body.

3. The adjustable pipe spool of claim 2, wherein the erosion ring is disposed at least partially within the outer body.

4. The adjustable pipe spool of claim 2, wherein a first end of the erosion ring engages the outer body when the inner body is in the retracted configuration.

5. The adjustable pipe spool of claim 2, wherein the erosion ring is formed of a different material than the inner body.

6. The adjustable pipe spool of claim 1, wherein rotation of the adjustment ring with respect to the inner body causes the inner body to axially translate with respect to the outer body.

7. The adjustable pipe spool of claim 6, wherein the direction of rotation of the adjustment ring with respect to the inner body causes the inner body to axially translate from the retracted configuration toward the extended configuration, or vice versa.

8. The adjustable pipe spool of claim 6, wherein the rotation key engages a far end of the slot when the inner body is in the extended configuration.

9. The adjustable pipe spool of claim 1, wherein the rotational adjustability of the inner body with respect to the outer body is limited by the width of the slot.

10. An adjustable pipe spool comprising:
an outer body; and
an inner body at least partially disposed within the outer body;
wherein the inner body is axially translatable with respect to the outer body; and
wherein the inner body is rotationally adjustable with respect to the outer body.

11. The adjustable pipe spool of claim 10, further comprising:
an erosion ring coupled to a first end of the inner body;
wherein the erosion ring moves axially and rotationally with the inner body.

12. The adjustable pipe spool of claim 11, wherein the erosion ring is disposed at least partially within the outer body.

13. The adjustable pipe spool of claim 11, wherein the erosion ring is formed of a different material than the inner body.

14. The adjustable pipe spool of claim 10, further comprising:
an adjustment ring rotationally coupled to the inner body;
wherein rotation of the adjustment ring with respect to the inner body causes the inner body to axially translate with respect to the outer body.

15. The adjustable pipe spool of claim 10, further comprising:
a rotation key maintained within the outer body and extending into a slot in the inner body.

16. The adjustable pipe spool of claim 15, wherein the interaction between the rotation key and the slot limits the axial translation of the inner body with respect to the outer body.

17. The adjustable pipe spool of claim 15, wherein the interaction between the rotation key and the slot limits the extent of rotational adjustability of the inner body with respect to the outer body.

18. An adjustable pipe spool comprising:
an outer body; and
an inner body;
wherein at least one of the outer body and the inner body are axially translatable and rotationally adjustable.

19. The adjustable pipe spool of claim 18, further comprising:
an erosion ring coupled to the inner body; and
wherein the inner body and the erosion ring are at least partially disposed within the outer body.

20. The adjustable pipe spool of claim 19, wherein the inner body and the erosion ring are axially translatable and rotationally adjustable with respect to the outer body.
